(19) United States
(12) Patent Application Publication
(10) Pub. No.: US 2024/0025554 A1
(43) Pub. Date: Jan. 25, 2024

(54) AIRCRAFT EQUIPPED WITH FUEL CELL SYSTEM AND THRUST CONTROL METHOD

(71) Applicants: Hyundai Motor Company, Seoul (KR); Kia Corporation, Seoul (KR)

(72) Inventor: Byung Wook Chang, Jung-gu (KR)

(21) Appl. No.: 18/086,009

(22) Filed: Dec. 21, 2022

(30) Foreign Application Priority Data
Jul. 21, 2022 (KR) 1020220090455

(51) Int. Cl. B64D 31/06; B64D 29/02; B64D 27/24; H01M 8/04089; H01M 8/0432; H01M 8/04537; H01M 8/04746

(52) U.S. Cl. CPC B64D 31/06; B64D 29/02; B64D 27/24; H01M 8/04097; H01M 8/0432; H01M 8/04589; H01M 8/04753; H01M 2250/20

(57) ABSTRACT

An aircraft includes a fuselage extending in a front-rear direction of the aircraft, main wings extending from sides of the fuselage, a fuel cell system located adjacent to a rear of the fuselage with respect to the main wings and configured to apply driving force to a nacelle located on each of the main wings, and a controller configured to transmit electrical energy applied from the fuel cell system to the nacelle. A center of gravity of the aircraft is located in the fuselage close to front ends of the main wings, and a flow rate of air flowing into the fuel cell system is controlled in response to an outside air condition of the aircraft.

### CROSS-REFERENCE TO RELATED APPLICATION

This application claims, under 35 U.S.C. § 119(a), the benefit of and priority from Korean Patent Application No. 10-2022-0090455 filed on Jul. 21, 2022, the entire contents of which are incorporated herein by reference.

### TECHNICAL FIELD

The present disclosure relates to an aircraft equipped with a fuel cell system and a thrust control method, and in some implementations, relates to an aircraft equipped with a fuel cell system for controlling a flow rate of air introduced to drive a fuel cell stack in consideration of an outside air condition of the aircraft driving a nacelle through the fuel cell system, and a thrust control method.

### BACKGROUND

An aircraft requires fuel supply to perform flight. Moreover, in fuel supply, it is customary to supply jet fuel to drive an engine, thereby receiving propulsion force.

However, recently, there has been a demand for a reduction in fuel consumption in the airline industry. Therefore, it is expected that a fuel cell system having high energy conversion efficiency will be introduced as an in-flight power supply source.

The fuel cell system may be classified as a phosphoric acid fuel cell (PAFC), a molten carbonate fuel cell (MCFC), a solid oxide fuel cell (SOFC), a polymer electrolyte membrane fuel cell (PEMFC), an alkaline fuel cell (AFC), a direct methanol fuel cell (DMFC), etc. depending on the type of electrolyte used, and may be applied to various application fields such as mobile power supply, transportation, and distributed power generation depending on the operating temperature, output range, etc. in addition to the type of fuel used. Among these fuel cells, the polymer electrolyte fuel cell has been applied to the aircraft field, which has been developed to replace the internal combustion engine.

As such, recently, research is being carried out to generate electricity through a chemical reaction between hydrogen and oxygen and to drive a nacelle to generate propulsion force of the aircraft. More specifically, the aircraft includes a hydrogen storage tank (H₂ Tank) in which hydrogen is stored, a fuel cell system that produces electricity through a redox reaction between hydrogen and oxygen, various devices for draining generated water, a high-voltage battery that stores electricity produced in a fuel cell stack, a controller that converts and controls the electricity produced, a motor that generates driving force, etc.

The fuel cell system includes a fuel cell stack that generates electrical energy, a fuel supply device that supplies fuel (hydrogen) to the fuel cell stack, and an air supply device that supplies air (oxygen), which is an oxidizing agent, required for an electrochemical reaction to the fuel cell stack.

As such, when the fuel cell system is employed as a driving system of the aircraft, the following limitations may exist. For instance, there may be a need to consider movement of a center of gravity according to a positional relation between a cabin located inside a fuselage and the fuel cell system. Furthermore, there may be a need to examine a positional relation of the hydrogen storage tank for supplying hydrogen and a layout for transmitting electrical energy generated through the fuel cell stack to a plurality of nacelles located on a main wing.

In addition, there may be a need to examine a layout of an inlet through which outside air flowing into the fuel cell system flows and the fuel cell system for setting the amount of compressed air transmitted to the fuel cell stack using the same.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to solve the above-described problems associated with prior art.

The present disclosure has been devised to solve the above problems, and an object of the present disclosure is to provide an aircraft that generates electrical energy for driving a nacelle located on a main wing from a fuel cell system.

Another object of the present disclosure is to provide an aircraft equipped with a fuel cell system for setting a flow rate of air introduced into the fuel cell system in response to an outside air condition and a thrust control method.

Another object of the present disclosure is to provide an aircraft for controlling the amount of air flowing into a fuel cell system in response to a change in air density in aircraft operation.

The objects of the present disclosure are not limited to the above-mentioned objects, and other objects of the present disclosure not mentioned may be understood by the following description, and may be seen more clearly by the examples of the present disclosure. In addition, the objects of the present disclosure may be realized by means and combinations thereof indicated in the claims.

In one aspect, the present disclosure provides an aircraft equipped with a fuel cell system, the aircraft including a fuselage located in a front-rear direction, main wings located to extend to both sides of a center of the fuselage, the fuel cell system located adjacent to a rear of the fuselage with respect to the main wings, and configured to apply a driving force to a nacelle located on each of the main wings, and a controller configured to transmit electrical energy applied from the fuel cell system to the nacelle, in which a flow rate of air flowing into the fuel cell system is controlled in response to an outside air condition of the aircraft.

In some implementations, the fuel cell system may include an inlet portion configured to introduce outside air, a blower located adjacent to the inlet portion, a compressor located at a rear of the blower to compress air introduced through the inlet portion, a fuel cell stack fluid-connected to the inlet portion, an air recirculation loop formed between an inlet end and a discharge end of the fuel cell stack, and a hydrogen storage tank fluid-connected to the fuel cell stack.

In some implementations, the aircraft may further include a high-voltage battery located on each of the main wings and configured to transmit stored electrical energy to the nacelle, in which the controller may be configured to transmit electrical energy to the nacelle through the fuel cell system and the high-voltage battery.

In some implementations, the outside air condition may include at least one of an altitude of the aircraft, a temperature of outside air, or a cruising speed of the aircraft.

In some implementations, the controller may be configured to determine a rate of rotation of a blower set according to the altitude of the aircraft according to the outside air condition, and to correct the rate of rotation of the blower to increase the rate of rotation so that a flow rate of air flowing into the fuel cell system increases when an outside air temperature is higher than a set temperature or a speed of the aircraft becomes relatively low.

In some implementations, the controller may be configured to determine the rate of rotation of a blower set according to the altitude of the aircraft according to the outside air condition, and to correct the rate of rotation of the blower to decrease the rate of rotation so that a flow rate of air flowing into the fuel cell system increases when an outside air temperature is lower than a set temperature or a speed of the aircraft becomes relatively high.

In some implementations, the controller may be configured to drive the air recirculation loop when oxygen concentration measured at the discharge end of the fuel cell stack is higher than a set value.

In another aspect, the present disclosure provides a method of controlling thrust of an aircraft equipped with a fuel cell system, the method including calculating a required current amount for providing thrust of the aircraft by a controller, calculating a flow rate of air flowing into a fuel cell stack in consideration of an outside air condition in response to the calculated required current amount, setting the rate of rotation of a blower located at an inlet portion according to the calculated air flow rate, measuring an actual flow rate of air flowing in according to rotation of the blower, and comparing the measured actual air flow rate and the calculated air flow rate to correct the flow rate.

In some implementations, the calculating of the flow rate of air flowing into a fuel cell stack in consideration of an outside air condition in response to the calculated required current amount may include calculating a flow rate of air flowing in based on air density set according to altitude information of the aircraft by the controller, and compensating the flow rate of the air flowing in based on an outside air temperature by the controller.

In some implementations, the compensating of the flow rate of the air flowing in based on an outside air temperature by the controller may include determining, by the controller, a temperature difference between a set temperature according to altitude information of the aircraft and an outside air temperature, and performing compensation to increase the rate of rotation of the blower when the temperature difference is greater than 0, and performing compensation to decrease the rate of rotation of the blower when the temperature difference is less than 0.

In some implementations, the calculating of a flow rate of air flowing into a fuel cell stack in consideration of an outside air condition in response to the calculated required current amount may include setting, by the controller, a rotation amount of the blower in consideration of a cruising speed of the aircraft.

In some implementations, the method may further include driving a recirculation blower of an air recirculation loop when oxygen concentration is higher than a set value as an outside air condition.

In some implementations, the calculating of a flow rate of air flowing into a fuel cell stack in consideration of an outside air condition in response to the calculated required current amount may include driving a recirculation blower of an air recirculation loop when oxygen concentration of outside air is higher than a set value.

Other aspects and implementations of the disclosure are discussed infra.

The above and other features of the disclosure are discussed infra.

### BRIEF DESCRIPTION OF THE DRAWINGS

The above and other features of the present disclosure will now be described in detail with reference to certain exemplary implementations thereof illustrated in the accompanying drawings which are given herein below by way of illustration only, and thus are not limitative of the present disclosure.

FIG. 1 is a top plan view illustrating an example layout of a fuel cell system of an aircraft fuselage.

FIG. 2 is a block diagram illustrating an example coupling relationship of the fuel cell system.

FIG. 3 illustrates a flow loop of an example of a fuel cell stack.

FIG. 4A is a flowchart illustrating an example of a method of controlling an air flow rate of the fuel cell stack according to altitude.

FIG. 4B is a flowchart illustrating an example of a method of controlling an air flow rate of the fuel cell stack according to a temperature condition.

FIG. 5 illustrates an example of an air recirculation loop of the fuel cell stack.

FIG. 6 illustrates an example of a change in air density according to altitude and temperature change.

FIG. 7 illustrates an example of a change in the rate of rotation of an air blower according to altitude and temperature change.

FIG. 8 illustrates an example of a change in the rate of rotation of the air blower according to a flight speed change.

FIG. 9 illustrates an example of a change in a rate of rotation of an air recirculation blower according to a change in oxygen concentration in the air.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, implementations of the present disclosure will be described in more detail with reference to the accompanying drawings. The implementations of the present disclosure may be modified in various forms, and the scope of the present disclosure should not be construed as being limited to the following implementations. The present implementation is provided to more completely describe the present disclosure to those of ordinary skill in the art.

In addition, a term such as “ . . . unit”, “ . . . system”, “ . . . cell”, etc. described in the specification means a unit that processes at least one function or operation, which may be implemented by hardware, software, or a combination of hardware and software.

In addition, a “set value” described in the specification is an arbitrary numerical value stored in a controller 8e, which may be determined according to a use environment.

In addition, the terms used in the specification are used only to describe specific implementations, and are not intended to limit the implementations. The singular expression includes the plural expression unless the context clearly dictates otherwise.

In addition, in this specification, an orientation of a configuration is set as a front or a rear considering a moving direction of a fuselage 5, one end close to the moving direction is described as the front, one end far from the moving direction is described as the rear, and the direction means a relative direction.

Hereinafter, the implementation will be described in detail with reference to the accompanying drawings, and in the description with reference to the accompanying drawings, the same or corresponding components are given the same reference numerals, and overlapping description thereof will be omitted.

The present disclosure relates to an aircraft equipped with a fuel cell system 8, and relates to a layout among a cabin 7 located in the fuselage 5, the fuel cell system 8 located at a rear end of the cabin 7, and nacelles 13, 14, 15, and 16 located on main wings 2.

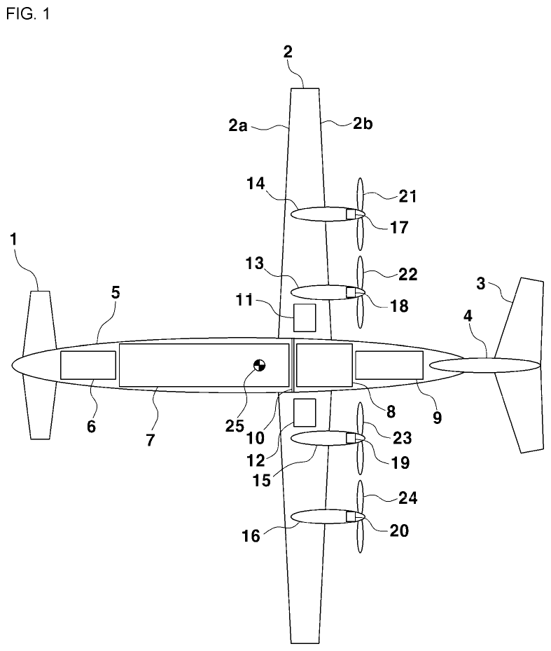

FIG. 1 illustrates a top view of the aircraft fuselage 5, and illustrates a location of the fuel cell system 8 and a center of gravity 25 formed in the aircraft fuselage 5 equipped with the fuel cell system 8.

As illustrated in the figure, the aircraft includes the fuselage 5 positioned long in a longitudinal direction, and includes a front horizontal stabilizer 1 located at a front end of the fuselage 5, the main wings 2 located extending from both sides of a longitudinal center of the fuselage 5, and a rear horizontal stabilizer 3 located at a rear end of the fuselage 5. A vertical stabilizer 4 located to be vertical to the rear horizontal stabilizer 3 is provided, and the vertical stabilizer 4 may be controlled so that left and right rotation in a longitudinal direction of the fuselage 5 is allowed.

A cockpit 6 of the aircraft is located at one front end of the fuselage 5, and an area for the cabin 7 located adjacent to the cockpit 6 is provided. Passengers or loads may be located in the area for the cabin 7, and the area may be used in a variety of ways.

In addition, the fuel cell system 8 is included, and the fuel cell system 8 is located adjacent to the rear of the fuselage 5 with respect to the main wings 2 located in the longitudinal center of the fuselage 5, and is configured to apply driving force to the nacelles 13, 14, 15, and 16 located on the main wings 2.

At least one of the nacelles 13, 14, 15, and 16 may be positioned on each of the main wings 2 located to extend to both sides with respect to the fuselage 5. In some implementations, two of the nacelles 13, 14, 15, and 16 are configured with respect to a main wing 2 located on one side, and the main wings 2 corresponding to each other with respect to the longitudinal direction of the fuselage 5 have the same number of the nacelles 13, 14, 15, and 16.

Furthermore, the nacelles 13, 14, 15, and 16 positioned on the main wings 2 may include propellers 21, 22, 23, and 24, and auxiliary electric propulsion units (EPUs) 17, 18, 19, and 20 for transmitting electrical energy applied from the fuel cell system 8 to the propellers 21, 22, 23, and 24.

That is, electrical energy generated from the fuel cell system 8 is applied as rotational force of the propellers 21, 22, 23, and 24 through the auxiliary EPUs 17, 18, 19, and 20, and may be converted into propulsion force of the aircraft. The propellers 21, 22, 23, and 24 are positioned on the main wings 2 to face the rear of the aircraft, and the auxiliary EPUs 17, 18, 19, and 20 are positioned inside housings of the nacelle 13, 14, 15, and 16 to conduct electricity with the fuel cell system 8 so that the propellers 21, 22, 23, and 24 rotate.

In some examples, the center of gravity 25 of the aircraft is configured to be located in the fuselage 5 close to front ends of the main wings 2. In some implementations, the center of gravity 25 may be located in front of a center of the fuselage 5 including the main wings 2 with respect to the fuselage 5 of the aircraft. The center of gravity 25 may be formed at a location adjacent to the rear end of the cabin 7.

A firewall 10 may be included between the cabin 7 and the fuel cell system 8, and the fuselage 5, in which the fuel cell system 8 is mounted, and the cabin 7 are separated from each other.

A hydrogen storage tank 9 configured to be able to supply hydrogen to the fuel cell stack 8d is included at a rear end of the fuel cell system 8. In some implementations, the hydrogen storage tank 9 is configured to be located at one end close to a tail of the fuselage 5.

In addition, the present disclosure may include high-voltage batteries 11 and 12 located on the main wings 2 extending to both sides of the fuselage 5. The high-voltage batteries 11 and 12 are configured to conduct electricity with the fuel cell stack 8d, and are configured to be charged by the fuel cell stack 8d. The charged high-voltage batteries 11 and 12 are configured to transmit electrical energy to the nacelles 13, 14, 15 and 16 positioned on the adjacent main wings 2, respectively. That is, the controller 8e of the fuel cell system 8 is configured to drive the nacelles 13, 14, 15 and 16 using the electrical energy generated from the fuel cell stack 8d, and to supplement the driving force of the nacelles 13, 14, 15 and 16 using the high-voltage batteries 11 and 12 when additional electrical energy is required. Furthermore, the controller 8e is configured to recharge the high-voltage batteries 11 and 12 through the fuel cell stack 8d when the charge amount of the high-voltage batteries 11 and 12 is less than or equal to a set value.

Moreover, the high-voltage batteries 11 and 12 of the present disclosure are configured to be located on the main wings 2 adjacent to the nacelles 13, 14, 15, and 16, the fuel cell system 8 is positioned adjacent to the fuselage 5 to which the main wings 2 are coupled, and locations are set to minimize the length of cables for conducting electricity with the nacelles 13, 14, 15, and 16, the high-voltage batteries 11 and 12, and the fuel cell system 8.

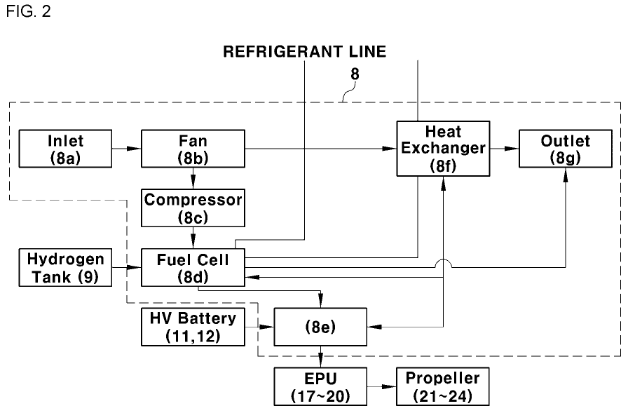

FIG. 2 is a block diagram illustrating a connection relationship of the fuel cell system 8 and the high-voltage batteries 11 and 12 of the present disclosure.

As illustrated in the figure, the fuel cell system 8 and the hydrogen storage tank 9 located at the rear end of the center of the fuselage 5 are included, and the high-voltage batteries 11 and 12 located on the respective main wings 2 are illustrated. The hydrogen storage tank 9 located adjacent to the rear of the fuel cell system 8 includes a hydrogen detection sensor, may measure the amount of hydrogen filling the hydrogen storage tank 9 in real time, and includes a manifold fluid-connected to the fuel cell stack 8d so that hydrogen can be exhausted. In addition, the hydrogen storage tank 9 may include a hydrogen receptacle so that hydrogen can be injected from the outside of the fuselage 5 or the outside of the hydrogen storage tank 9. The manifold of the hydrogen storage tank 9 may be configured to include a pressure relief valve or regulator for performing pressure relief.

Hydrogen stored in the hydrogen storage tank 9 can be introduced into the fuel cell stack 8d, and electrical energy is generated through the fuel cell stack 8d.

Furthermore, the fuel cell system 8 of the present disclosure includes an inlet portion 8a configured to introduce outside air. The inlet portion 8a may be formed at a position adjacent to an upper end of the fuselage 5, and is configured so that outside air flows into the fuel cell system 8 when the aircraft is propelled. In some implementations, the inlet portion 8a is configured so that outside air and hydrogen are introduced into the fuel cell stack 8d to generate electrical energy through a reaction. After the reaction is completed, hydrogen, air, and reaction water discharged from the fuel cell stack 8d are discharged to the outside of the fuselage 5 through an outlet of the fuel cell system 8.

Furthermore, the controller 8e is included to transmit electrical energy applied from the fuel cell stack 8d to the nacelles 13, 14, 15, and 16, and the controller 8e is configured to provide electrical energy generated in communication with the auxiliary EPUs 17, 18, 19, and 20 located on the nacelles 13, 14, 15, and 16 to the nacelles 13, 14, 15, and 16 or the high-voltage batteries 11 and 12. In addition, the controller 8e controls a flow rate of hydrogen and oxygen flowing into the fuel cell stack 8d in response to a thrust request.

Moreover, the controller 8e controls rotational force of a blower 8b located at a rear end of the inlet portion 8a in response to a cruising speed of the aircraft, air density according to altitude, and air density according to temperature. In addition, the controller 8e is configured to control the driving amount of a recirculation blower 31 for driving an air recirculation loop 30 according to the oxygen density at a discharge end of the fuel cell stack 8d.

In some implementations, the controller 8e and the auxiliary EPUs 17, 18, 19, and 20 are configured to set the driving amount of the fuel cell system 8 and energy consumption of the nacelles 13, 14, 15, and 16 in response to a request from a driver. In addition, the controller 8e is configured to measure the charge amount of the high-voltage batteries 11 and 12, and charge the high-voltage batteries 11 and 12 through the fuel cell stack 8d when the measured charge amount is less than or equal to a set value.

In addition, the controller 8e may be configured to drive the fuel cell stack 8d to generate electrical energy in response to an electrical energy request from the auxiliary EPUs 17, 18, 19, and 20 located on the nacelles 13, 14, 15, and 16, and to provide additionally required electrical energy to the nacelles 13, 14, 15, and 16 through the high-voltage batteries 11 and 12.

As such, the high-voltage batteries 11 and 12 may maintain a constant state of charge to be able to back up driving of the fuel cell stack 8d.

The fuel cell stack 8d is configured to introduce outside air through the inlet portion 8a, and may include the blower 8b positioned at a rear end of the inlet and a compressor positioned at a rear end of the blower 8b. The compressor according to the present disclosure is provided to compress inlet gas (air) sucked into the fuel cell system and supply the inlet gas to the fuel cell stack 8d.

In addition, air branched from the blower 8b may be introduced into a heat exchanger 8f, and may be connected to a refrigerant loop circulating through the heat exchanger 8f and the fuel cell stack 8d. Accordingly, a reaction temperature inside the fuel cell stack 8d may be set.

For reference, the fuel cell stack 8d may be formed in various structures capable of generating electricity through a redox reaction between a fuel (for example, hydrogen) and an oxidizing agent (for example, air).

For example, the fuel cell stack 8d includes a membrane electrode assembly (MEA) having catalyst electrode layers where electrochemical reactions occur attached to both sides of an electrolyte membrane through which hydrogen ions move, a gas diffusion layer (GDL) that evenly distributes reactive gases and transfers generated electrical energy, a gasket and a fastener for maintaining airtightness and proper clamping pressure of the reaction gases and cooling water, and a bipolar plate for moving the reactive gases and cooling water.

More specifically, in the fuel cell stack 8d, hydrogen serving as a fuel and air (oxygen) serving as an oxidizing agent are respectively supplied to an anode and a cathode of a membrane electrode assembly through a flow path of the bipolar plate, hydrogen is supplied to the anode, and air is supplied to the cathode.

Hydrogen supplied to the anode is decomposed into hydrogen ions (protons) and electrons by a catalyst of electrode layers on both sides of the electrolyte membrane. Of the hydrogen ions and the electrons, only the hydrogen ions are selectively transferred to the cathode through the electrolyte membrane, which is a cation exchange membrane. At the same time, the electrons are transferred to the cathode through the gas diffusion layer and the bipolar plate, which are conductors.

At the cathode, the hydrogen ions supplied through the electrolyte membrane and the electrons transferred through the bipolar plate meet with oxygen in the air supplied to the cathode by an air supply device to generate water. At this time, a flow of electrons through an external conductor is generated due to movement of hydrogen ions, and a current is generated by the flow of these electrons.

Electrical energy is generated through the flow of the electrons generated in this way, thereby applying driving force to the nacelles 13, 14, 15, and 16. In some implementations, the propulsion force of the aircraft is generated by rotating the propellers 21, 22, 23, and 24 located on the nacelles 13, 14, 15, and 16.

Water and air generated as by-products reacted in the fuel cell stack 8d are discharged to the outside of the fuselage 5 through a discharge portion 8g.

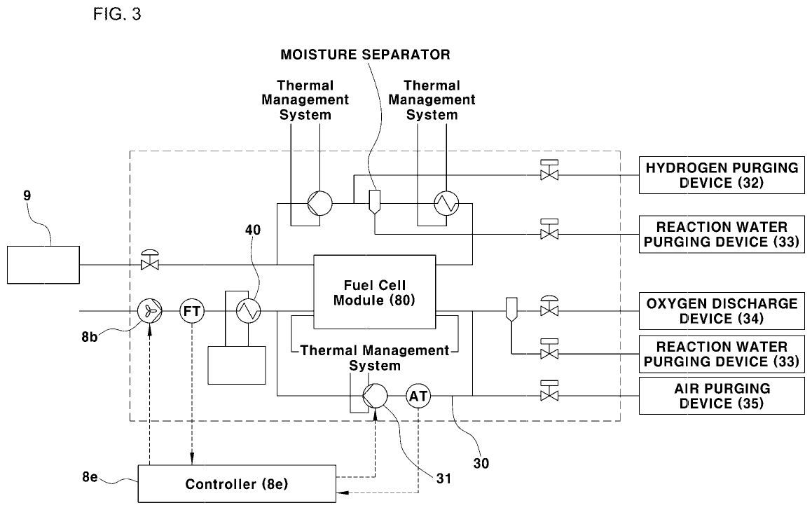

FIG. 3 illustrates a connection relationship between the fuel cell stack 8d, and an air flow rate control loop and the air recirculation loop 30 coupled to the fuel cell stack 8d.

The inlet portion 8a of the fuel cell system 8 of the present disclosure is located adjacent to the upper end of the fuselage 5, and at least a part of the outside air flowing along the upper end of the fuselage 5 is introduced into the fuel cell system 8.

Moreover, the controller 8e is configured to calculate the oxygen concentration and humidity of the outside air introduced through a sensor unit, and to drive the blower 8b and the compressor according to the calculated oxygen concentration and humidity. In addition, the controller 8e is configured to perform driving of the heat exchanger 8f by determining the outside air temperature of the aircraft, and is configured to set a temperature of a refrigerant flowing through the fuel cell stack 8d.

The fuel cell stack 8d is configured so that oxygen in the air is supplied through an inlet end, and may include the blower 8b positioned at the rear end of the inlet portion 8a and a humidifier positioned at the rear end of the blower 8b. Accordingly, the flow rate of the air flowing into the fuel cell system 8 along the inlet portion 8a is controlled by the blower 8b, and furthermore, the humidity is controlled through the humidifier. In some implementations, a flow meter is included between the blower 8b and the humidifier to measure the flow rate of the air introduced into the fuel cell system 8. That is, the controller 8e may control humidification and the flow rate of the air introduced into the fuel cell stack 8d, and is configured to be able to control the driving amount of the blower 8b in response to an outside air condition.

Furthermore, an oxygen discharge device 34 capable of discharging residual oxygen after the reaction of the fuel cell stack 8d and a reaction water purging device 33 configured to discharge reaction water may be connected. In addition, a recirculation loop connected from the air discharge end of the fuel cell stack 8d to an inlet end of the fuel cell stack 8d may be included, and the controller 8e may set circulation so that the air from the discharge end of the fuel cell stack 8d is re-introduced into the fuel cell stack 8d. In addition, it is possible to further include an oxygen discharge device 34 for discharging air by being located at the discharge end of the fuel cell stack 8d.

The controller 8e may include a valve controlled so that hydrogen is supplied from the hydrogen storage tank 9 to the fuel cell stack 8d, and may control a flow rate of hydrogen flowing into the fuel cell stack 8d. In addition, it is possible to include a hydrogen purging device 32, an air purging device 35, and the reaction water purging device 33 configured so that residual hydrogen and reaction water can be discharged after reaction in the fuel cell stack 8d.

As such, the controller 8e may control the flow rate and humidity of the air introduced into the fuel cell stack 8d in response to a request for propulsion force from the aircraft, and may control the flow rate of hydrogen. Furthermore, the controller 8e is configured to be able to control the flow rate of the air introduced through the inlet portion 8a in consideration of the altitude of the aircraft, the humidity and temperature of the introduced air, and the cruising speed of the aircraft as the outside air conditions of the aircraft.

In some implementations, the controller 8e may be configured to control the rate of rotation of the blower 8b based on the density of air, and at a relatively high altitude measured through an altitude sensor of the aircraft, the air density is relatively low, and thus the rate of rotation of the blower 8b is increased. That is, in the case of an altitude greater than a set value stored in the controller 8e, the rate of rotation of the blower 8b is controlled based on air density information according to the altitude sensor. In some implementations, the controller 8e may be configured to store a set value of the air density in response to the flight altitude of the aircraft, and to control the rate of rotation of the blower 8b based on the air density set in response to an actual altitude of the aircraft.

In addition, the controller 8e controls the blower 8b based on the outside air temperature measured by a temperature sensor of the aircraft. That is, when the measured outside air temperature is a relatively low temperature when compared to the temperature according to the altitude stored in the controller 8e, the rate of rotation of the blower 8b is increased. In some examples, when a relatively high temperature is measured when compared to the temperature according to the altitude stored in the controller 8e, the rate of rotation of the blower 8b is increased. In some implementations, the controller 8e may be configured to control the rotation amount of the blower 8b in response to a temperature difference actually measured based on an air density set value based on the altitude and temperature set in the controller 8e.

In this way, the controller 8e is configured to control the rotation amount of the blower 8b based on altitude information of the aircraft and is additionally configured to compensate the rotation amount of the blower 8b based on the outside air information measured by the temperature sensor.

Moreover, the controller 8e is configured to control the rotation amount of the blower 8b in response to the cruising speed of the aircraft. For example, the controller 8e performs a control operation to decrease the rate of rotation of the blower 8b when the aircraft cruising speed is relatively fast, and to increase the rate of rotation of the blower 8b when the aircraft cruising speed is relatively slow. The cruising speed of the aircraft is determined based on the set value stored in the controller 8e, and the set cruising speed and a current cruising speed of the aircraft are compared to each other to control the blower 8b in response to a difference value therebetween. In some implementations, the controller 8e is configured to compensate the rate of rotation of the blower 8b according to the aircraft cruising speed based on the rate of rotation of the blower 8b set according to the altitude.

As such, the controller 8e of the present disclosure is configured to control the rate of rotation of the blower 8b in consideration of at least one of an altitude condition of the aircraft, the density of the outside air, the outside air temperature, or the cruising speed of the aircraft as an outside air condition.

In summary, the controller 8e is configured to determine the rate of rotation of the blower 8b according to the altitude of the aircraft including the set temperature as the outside air condition, and to correct the rate of rotation of the blower 8b to increase the rate of rotation when the outside air temperature becomes higher than the set value or the speed of the aircraft becomes relatively low. Furthermore, the controller 8e is configured to correct the rate of rotation of the blower 8b to decrease the rate of rotation when the outside air temperature becomes lower than the set value or the speed of the aircraft becomes relatively high.

Furthermore, the controller 8e is configured to measure a flow rate of air actually introduced through a flow meter located at the rear end of the air blower 8b, and to correct a flow rate of air introduced from the outside through the inlet portion 8a when an additional flow rate is required when compared to a requested air flow rate.

In this way, when a flow rate requested to obtain thrust from the controller 8e is introduced, electrical energy is produced from the fuel cell stack 8d of the fuel cell system 8, and the electrical energy is transmitted to the nacelles 13, 14, 15, and 16.

The air recirculation loop 30 includes an air recirculation path formed between an inlet end through which air is introduced into the fuel cell stack 8d and a discharge end through which air in the fuel cell stack 8d is discharged, and is configured so that the air recirculation path is fluid-connected to the air purging device 35.

The controller 8e is configured to measure oxygen concentration of air supplied to the fuel cell stack 8d, and to control the driving amount of the recirculation blower 31 located in the air recirculation path so that exhaust air is recirculated to an inlet of a fuel cell stat when the measured oxygen concentration is higher than concentration set in the controller 8e.

In some implementations, when the oxygen concentration of the exhaust air measured by the controller 8e is less than the set value, dry air and water are separated by a moisture separator and discharged to the outside of the aircraft fuselage 5.

That is, in this way, it is possible to provide an effect of increasing reaction performance of the fuel cell stack 8d by recirculating used air according to the oxygen concentration of the air discharged from the fuel cell stack 8d.

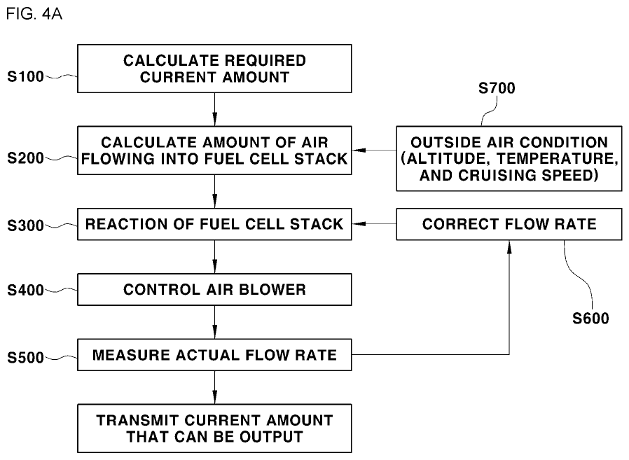

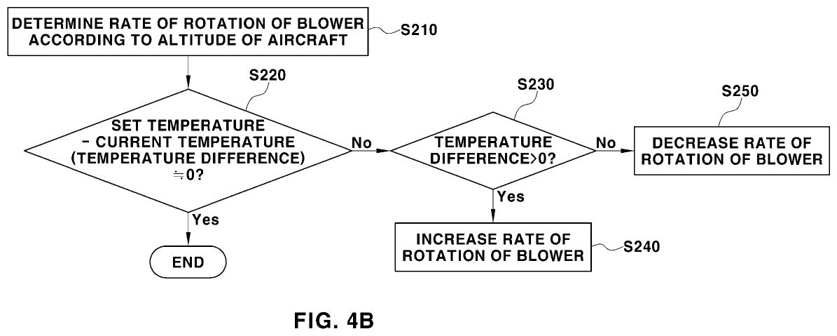

FIG. 4A illustrates a control step of controlling a flow rate of introduced air in response to the outside air condition.

The controller calculates electrical energy (required current amount) required according to the thrust of the aircraft (S100), and determines a flow rate of air flowing into the fuel cell stack in consideration of the outside air condition in response to the calculated required current amount (S200).

The step of determining the flow rate of the air flowing into the fuel cell stack includes determining the amount of air in consideration of the altitude, the outside air temperature, and the cruising speed of the aircraft (S700). In some implementations, the controller of the present disclosure is configured to store the rate of rotation of the blower when the altitude changes according to the set temperature, and to determine the required air amount of the fuel cell stack based thereon. Moreover, when the altitude stored in the controller changes, the rate of rotation of the blower is compensated according to a difference between the set temperature and the outside air temperature.

In addition, in the step S700 of considering the outside air temperature and the cruising speed, a control operation is performed to decrease the rate of rotation of the blower when the cruising speed is higher than a set speed, and to increase the rate of rotation of the blower when the cruising speed is less than the set speed. That is, when the required air amount is determined, the rotation amount of the blower is set in consideration of the cruising speed.

When a flow rate of a flow into the fuel cell stack is set, a reaction of the fuel cell stack is performed (S300), and the rate of rotation of the blower located at the inlet portion is set in response to the calculated air flow rate (S400).

Thereafter, a flow rate of air that actually flows into the inlet portion is measured through the flow meter located at the rear end of the blower (S500), and a flow rate of air flowing into the fuel cell stack is corrected so that electrical energy corresponding to the required current amount can be output (S600).

Furthermore, FIG. 4B illustrates in more detail a step of calculating the amount of inflow air of the fuel cell stack.

The rate of rotation of the blower stored in the controller is variable when the altitude changes according to the set temperature. That is, the controller is configured to store the rate of rotation of the blower according to the altitude of the aircraft, and to apply the rate of rotation of the blower when the corresponding aircraft is located at a predetermined altitude (S210).

Furthermore, a step of determining a temperature difference between a temperature set at the corresponding altitude and the outside air temperature of the aircraft is performed (S220). When the temperature difference has a value greater than 0 in the corresponding step (S230), a control operation is performed to increase the rate of rotation of the blower (S240). In some examples, when the temperature difference is less than 0 (S250), a control operation is performed to reduce the rate of rotation of the blower (S260).

As such, the rate of rotation of the blower is controlled by comparing the temperature set at the same altitude with the actual outside air temperature in order to generate a required amount of current applied to a nacelle by sufficiently supplying a flow rate of oxygen flowing into the fuel cell stack according to a difference in air density.

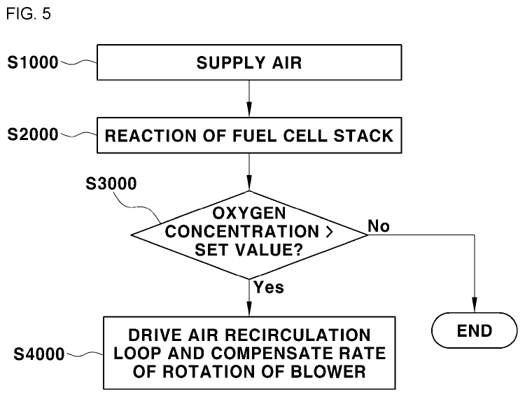

FIG. 5 illustrates an operation of an air recirculation loop formed between the inlet end and the discharge end of the fuel cell stack according to the oxygen concentration of the outside air.

The rate of rotation of the blower is set in consideration of the case of driving the air recirculation loop in the step (S200) of calculating the flow rate of the air flowing into the fuel cell stack in consideration of the outside air condition in response to the calculated required current amount. That is, when the air recirculation loop is driven, the flow rate of the air flowing into the fuel cell system from the inlet portion through the blower may be reduced. That is, the rotation amount of the blower located at the rear end of the inlet portion is controlled in consideration of the oxygen concentration in the air as the outside air condition.

In some implementations, the blower is driven according to the altitude, temperature, and cruising speed conditions to supply air to the fuel cell stack (S1000), and a reaction is performed to generate electrical energy through the supplied fuel cell stack (S2000).

Thereafter, when the outside oxygen concentration measured through the sensor unit is higher than the set value (S3000), the recirculation blower of the air recirculation loop is driven to perform a control operation so that air discharged from the discharge end of the fuel cell stack flows to the inlet end of the fuel cell stack (S4000). Furthermore, when the air recirculation loop is driven, the set rate of rotation of the blower is controlled by the controller so that the rate is decreased, and there is air flowing to the inlet end of the fuel cell stack through the air recirculation loop, and thus a configuration for reducing an inflow of outside air is adopted.

In some examples, when the outside oxygen concentration is less than the set value (S3000), the corresponding logic is terminated.

As such, the present disclosure may control the flow rate of air introduced into the fuel cell stack by considering the oxygen concentration condition as an outside air condition, and is configured to compensate the rate of rotation of the blower.

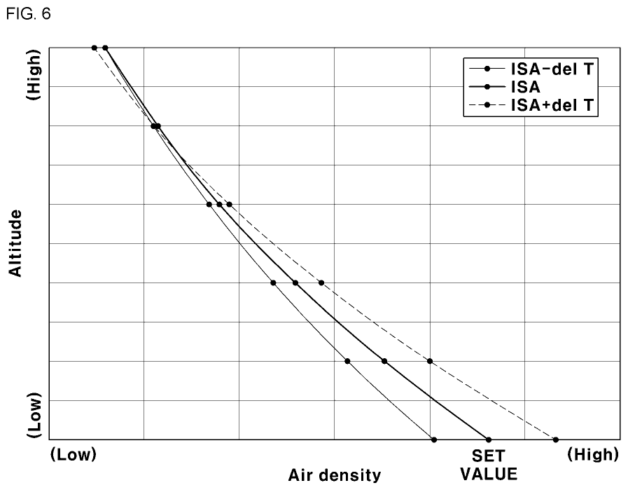

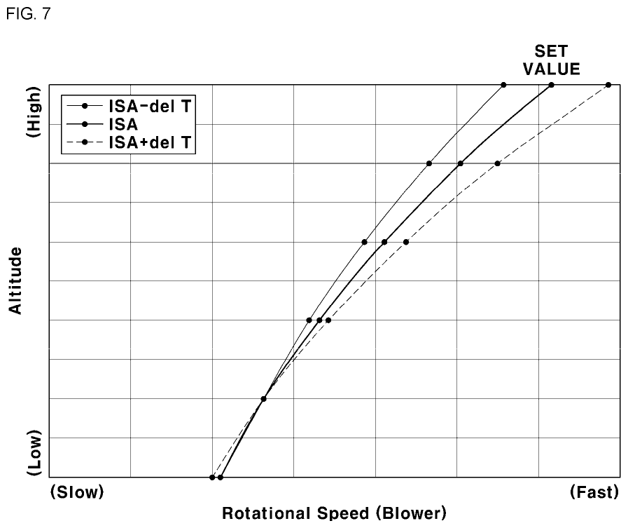

FIG. 6 illustrates a change in air density according to altitude, and further illustrates a change in air density at the same altitude according to temperature change. In addition, FIG. 7 illustrates data for controlling the rotation amount of the blower 8b in response to a change in altitude and a change in outside air temperature.

As the flight altitude of the aircraft increases, the density of air is reduced, and the controller 8e performs a control operation to increase a driving rotational speed of the blower 8b located at the rear end of the inlet portion 8a at low air density. Furthermore, the controller 8e may store the reduction amount of the air density according to the altitude of the aircraft, and control the rate of rotation of the blower 8b based thereon.

Moreover, the controller 8e may set the rate of rotation of the blower 8b according to the flight altitude of the aircraft, and correct the rate of rotation of the blower 8b in response to the outside air temperature measured through the temperature sensor. That is, as illustrated in the figure, when the temperature is higher than a reference temperature set at the same altitude, the air density is lowered, and the controller 8e corrects the driving amount of the blower 8b so that the rate of rotation is higher than the set rate of rotation of the blower 8b.

In addition, when the outside air of the aircraft has a temperature lower than a set reference temperature, the air density is increased, and the controller 8e corrects the driving amount of the blower 8b so that the rate of rotation is lower than the set rate of rotation of the blower 8b.

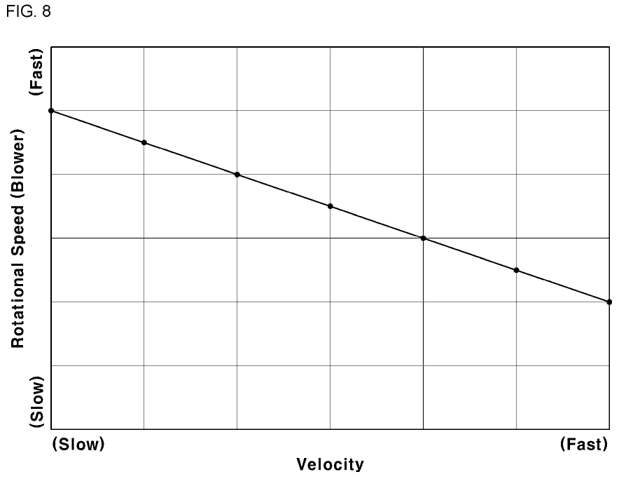

FIG. 8 illustrates a change in which the driving rotational speed of the blower 8b becomes smaller as the cruising speed of the aircraft increases.

The controller 8e is configured to measure the cruising speed through a speed sensor of the aircraft, and to decrease the driving rotational speed of the blower 8b located at the rear end of the inlet portion 8a as the cruising speed increases above a set value in the controller 8e. That is, as the cruising speed increases, even when the blower 8b is not driven, the amount of air introduced through the inlet portion 8a increases compared to the relatively low cruising speed, and thus the driving force applied to the blower 8b may be reduced.

In addition, the controller 8e performs a control operation so that, when the measured cruising speed of the aircraft is smaller than the set cruising speed, the driving force applied to the blower 8b is increased to increase air introduced into the fuel cell stack 8d.

As such, the controller 8e of the present disclosure is configured to control the flow rate of the air introduced into the fuel cell system 8 by performing correction to reduce the driving rotation speed of the blower 8b in response to the aircraft cruising speed.

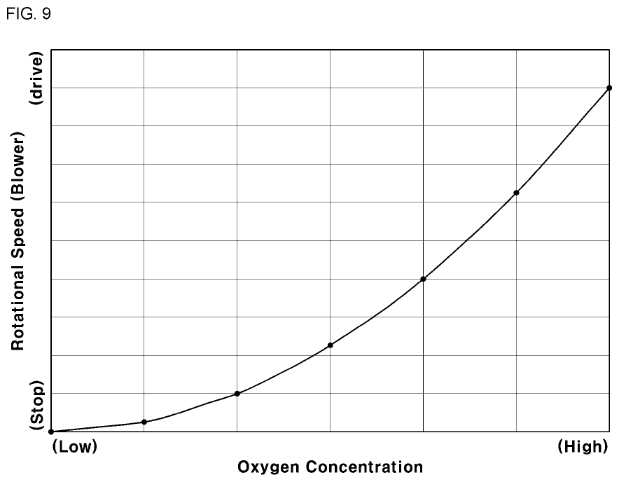

Furthermore, FIG. 9 illustrates a driving change of the air recirculation loop 30 according to the oxygen concentration change.

When the oxygen concentration in the air at the discharge end of the fuel cell stack 8d is high, the rate of rotation of the recirculation blower (pump) located in the air recirculation loop 30 is increased to increase a flow rate of air circulated to the inlet of the fuel cell stack 8d through the recirculation path.

In some implementations, when the oxygen concentration in the air measured by the controller 8e is higher than the set value, the air introduced into the fuel cell system 8 through the inlet portion 8a moves from the inlet of the fuel cell stack 8d to an anode-side supply manifold of the fuel cell stack 8d, and flows back to the inlet of the fuel cell stack 8d along an intermediate circulation loop through an anode-side discharge manifold of the fuel cell stack 8d. Thereafter, the air discharged from the fuel cell stack 8d is discharged to the outside of the aircraft fuselage 5 through the discharge portion 8g.

As illustrated in the figure, when the oxygen concentration is higher than the set value set in the controller 8e, a control operation may be performed to increase the driving amount of the recirculation blower 31 located in the air recirculation path so that air flowing to the discharge end of the fuel cell stack 8d is recirculated to the inlet end of the fuel cell stack 8d.

The present disclosure may obtain the following effects by the configuration, combination, and use relationship described above and the present implementation.

The present disclosure has the effect of providing longitudinal stability by providing arrangement of the fuel cell system inside the fuselage and the nacelles.

In addition, the present disclosure may control a flow rate of air flowing into the fuel cell system in consideration of the outside air condition, and thus has an effect of increasing system efficiency.

Furthermore, the present disclosure drives the recirculation loop of the fuel cell stack in consideration of the oxygen concentration condition, and thus has an effect of efficiently operating the system.

The above detailed description is illustrative of the present disclosure. In addition, the above description shows and describes examples of the present disclosure, and the present disclosure may be used in various other combinations, modifications, and environments. That is, changes or modifications are possible within the scope of the concept of the disclosure disclosed in this specification, the scope equivalent to the described disclosure, and/or within the scope of skill or knowledge in the art. The implementations describe the best state for implementing the technical idea of the present disclosure, and various changes required in specific application fields and uses of the present disclosure are possible. Accordingly, the detailed description of the present disclosure is not intended to limit the present disclosure to the disclosed implementations. In addition, the appended claims should be construed as including other implementations.

What is claimed is:

1. An aircraft comprising:
a fuselage that extends in a front-rear direction of the aircraft;
main wings that extend from sides of the fuselage, respectively;
a nacelle located at each of the main wings;
a fuel cell system located at a rear portion of the fuselage relative to the main wings, the fuel cell system being configured to generate electrical energy for driving the nacelle; and
a controller configured to transmit the electrical energy from the fuel cell system to the nacelle,
wherein the controller is configured to control a flow rate of air into the fuel cell system based on an outside air condition of the aircraft.

2. The aircraft of claim 1, wherein the fuel cell system comprises:
an inlet portion configured to receive outside air;
a blower located adjacent to the inlet portion;
a compressor located downstream relative to the blower and configured to compress the air received through the inlet portion;
a fuel cell stack that is fluidly connected to the inlet portion;
an air recirculation loop defined between an inlet end and a discharge end of the fuel cell stack; and
a hydrogen storage tank that is fluidly connected to the fuel cell stack.

3. The aircraft of claim 2, further comprising:
a battery located at each of the main wings and configured to store electrical energy,
wherein the controller is further configured to transmit the electrical energy stored in the battery to the nacelle.

4. The aircraft of claim 1, wherein the outside air condition includes at least one of an altitude of the aircraft, a temperature of outside air, or a speed of the aircraft.

5. The aircraft of claim 4, wherein the fuel cell system comprises a blower configured to cause the outside air to be introduced into the fuel cell system, and
wherein the controller is further configured to:
determine a rate of rotation of the blower based on the altitude of the aircraft of the outside air condition; and
based on the temperature of the outside air being higher than a set temperature or the speed of the aircraft being less than a set speed, increase the rate of rotation of the blower to thereby increase the flow rate of air into the fuel cell system.

6. The aircraft of claim 4, wherein the fuel cell system comprises a blower configured to cause the outside air to be introduced into the fuel cell system, and
wherein the controller is further configured to:
determine a rate of rotation of the blower based on the altitude of the aircraft of the outside air condition; and
based on the temperature of the outside air being lower than a set temperature or the speed of the aircraft being greater than a set speed, decrease the rate of rotation of the blower.

7. The aircraft of claim 2, wherein the controller is configured to:
obtain an oxygen concentration measured at the discharge end of the fuel cell stack; and
drive the air recirculation loop based on the oxygen concentration being higher than a set value.

8. A method for controlling an aircraft including a fuel cell system, the method comprising:
determining, by a controller, a current amount for providing thrust to the aircraft;
calculating an air flow rate of air into the fuel cell system based on the determined current amount and an outside air condition;
based on the calculated air flow rate, setting a rate of rotation of a blower that is located at an inlet portion of the fuel cell system;
measuring an actual air flow rate of air into the fuel cell system based on rotating the blower at the set rate of rotation;
comparing the measured actual air flow rate and the calculated air flow rate; and
adjusting the air flow rate of air into the fuel cell system based comparing the measured actual air flow rate and the calculated air flow rate.

9. The method of claim 8, wherein calculating the air flow rate comprises:
calculating the air flow rate based on an air density corresponding to altitude information of the aircraft; and
compensating the calculated air flow rate based on an outside air temperature.

10. The method of claim 9, wherein compensating the calculated air flow rate comprises:
determining a set temperature corresponding to the altitude information of the aircraft; and
determining a temperature difference between the set temperature and the outside air temperature, and
wherein adjusting the air flow rate comprises:
increasing the rate of rotation of the blower based on the temperature difference being greater than zero, and
decreasing the rate of rotation of the blower based on the temperature difference being less than zero.

11. The method of claim 8, wherein calculating the air flow rate comprises:
setting, by the controller, the rate of rotation of the blower based on a speed of the aircraft.

12. The method of claim 8, wherein the fuel cell system comprises an air recirculation loop including a recirculation blower, and
wherein the method further comprises driving the recirculation blower based on the outside air condition having an oxygen concentration higher than a set value.

13. The method of claim 8, wherein the fuel cell system comprises an air recirculation loop including a recirculation blower, and
wherein calculating the air flow rate comprises driving the recirculation blower based on an oxygen concentration of outside air being higher than a set value.
